(19) United States
(12) Patent Application Publication
(10) Pub. No.: US 2008/0300146 A1
(43) Pub. Date: Dec. 4, 2008

(54) Bio Chip Device with a Sample Compartment and a Light Sensitive Element, Method for the Detection of Fluorescent Particles Within at Least One Sample Compartment of a Bio Chip Device

(75) Inventors: Marc Wilhelmus Gijsbert Ponjee, Eindhoven (NL); Mark Thomas Johnson, Eindhoven (NL); Marcello Leonardo Mario Balistreri, Best (NL); Maarten Marinus Johannes Wilhelmus Van Herpen, Eindhoven (NL); Derk Jan Wilfred Klunder, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,145

(22) PCT Filed: Nov. 23, 2006
(86) PCT No.: PCT/IB2006/054397

§ 371 Date: May 28, 2008

(30) Foreign Application Priority Data
Nov. 29, 2005 (EP) 05111436.1

(51) Int. Cl. C40B 60/12; C40B 30/10

(52) U.S. Cl. 506/12; 506/39

(57) ABSTRACT

The invention provides a bio chip device comprising at least one sample compartment and at least one light sensitive element, the at least one sample compartment being provided on a first side of the at least one light sensitive element, wherein incident light is provided incident from a second side opposite of the first side of the at least one light sensitive element. Further, the invention provides a method for the detection of fluorescent particles within at least one sample compartment of a bio chip device.

The present invention relates to a bio chip device comprising at least one sample compartment and at least one light sensitive element. The present invention further relates to a method for the detection of fluorescent particles within at least one sample compartment of a bio chip device.

Micro-fluidic devices are at the heart of most bio-chip technologies, being used for both the preparation of fluidic (e.g. blood based) samples and their subsequent analysis. Integrated devices comprising bio-sensors and micro-fluidic devices are known. There are different names for these devices, such as DNA/RNA-Chips, bio-chips, gene-chips and lap-on-a-chip. In particular, high throughput screening on (micro)arrays is one of the new tools for biochemical analysis, for instance employed in diagnostics. These bio chip devices comprise small volume wells or reactors, in which chemical or biochemical reactions are examined, and may regulate, transport, mix and store minute quantities of liquid separately, rapidly and reliably to carry out desired physical, chemical and biochemical reactions and analysis in large numbers. By carrying out assays in small volumes, significant savings can be achieved in time and cost of targets, compounds and reagents.

Fluorescence analysis is one of the most widely used techniques in the fields of biochemistry and molecular biophysics. Fluorescence detection methods are very attractive because of the current biochemistry protocols already incorporate fluorescent labels. Therefore, chip based assays can easily be incorporated into existing protocols without changing the biochemistry. For instance, fluorescent labelling of proteins is most common in biosciences and millions of fluorescent immuno assays are performed worldwide every year. In addition, reactions such as Sanger sequencing and the polymerase chain reaction (PCR) have been adapted to fluorescent labelling methods. In fact, real time quantitive PCR-amplification (RQ-PCR), which is a fast growing technology for medical diagnostics, is being performed with high efficiency using fluorescent labels. In this technology, the presence of amplified products is quantitatively recorded during temperature processing using reporter molecules (e.g. molecular beacons, scorpions, etc.) that generate an optical signal that is measured in real time in the same device. The recorded signal is a measure for the presence as well as the concentration of specific nucleic acid molecules, for example (but not limited to) a bacterium or a set of bacteria. Conclusively, fluorescence detection can be used in a variety of applications on an analysis chip, such a the fluorescence detection of optical beacons during DNA-amplification, labelled proteins and immobilised or hybridised (labelled) nucleic acids on a surface.

Bio chip devices are generally known. For example, US-Patent application US 2004/0038390 A1 discloses an optical instrument provided to simultaneously illuminating two or more spaced-apart reaction regions with an excitation beam generated by a light source. A collimating lens can be disposed along a beam path between the light source and the reaction regions to form bundles of collimated excitation beams, wherein each bundle corresponds to a respective reaction region. In the bio chip device according to US-Patent application US 2004/0038390 A1 the detection of fluorescence signals of a biochip is done using an optical detection system, comprising a light source, optical filters and sensors, localised in a bench top/laboratory machine, to quantify the amount of fluorophores present. One drawback of the known device is that the fluorescence detection system used in bench top/laboratory machines generally require expensive optical components to acquire and analyse the fluorescent signals. In particular, expensive optical filters with sharp wave-length cut off are used to obtain the needed sensitivity of these optical systems. This limits the possibility to provide a bio chip device which can be processed simply and cheaply by untrained personnel and/or automatically and without highly sophisticated machinery.

It is therefore an objective of the present invention to provide a bio chip device which can be used as a disposable bio chip device and where results of biochemical reactions can be read out simply, easily and in a cost-effective manner without a loss of accuracy.

The above objective is accomplished by a bio chip device comprising at least one sample compartment and at least one light sensitive element, the at least one sample compartment being provided on a first side of the at least one light sensitive element, wherein incident light is provided incident from a second side opposite of the first side of the at least one light sensitive element.

An advantage of the device according to the present invention is that it is possible to realise the detection of bio assay results in a much easier, more cost-effective and faster manner than it was possible by devices and methods of the prior art. For example, it is possible to realise the detection of bio assay results without the use of expensive optical filters and/or expensive bench top/laboratory machines.

A further advantage is that on-chip fluorescence signal acquisition systems improve both the speed and the reliability of analysis bio chip devices, e.g. DNA chip hybridisation pattern analysis.

Further, it is advantageous that the reduced costs of both the bio chip device and the instrumentation needed to read out the analysis results of biochemical assays makes it possible to use the bio chip devices in portable hand-held instruments for applications such as point-of-care diagnostics and roadside testing because no central bench-top machine is needed anymore.

A further advantage is that the solid angle of collection of fluorescent light increases by incorporating the light sensitive element into the bio chip device. In addition, the number of medium boundaries and corresponding reflections decreases.

Still a further advantage is that a bench top machine will become able to handle versatile bio chip devices and a variety of bio chips. Having the optical sensor as a part of the bench-top machine demands the mounting of a specific filter set for a specific assay, which hampers the parallel (multiplexed) detection of fluorescent labels with various excitation and/or emission spectra. Therefore, being able to read-out on-chip optical sensors (light sensitive elements) allows for a flexible multi-purpose bench-top machine and opens the route towards standardisation of biochips, bench-top machines and components thereof.

In a preferred embodiment of the present invention, the bio chip device comprises a lid on the first side of the at least one light sensitive element, wherein the lid is provided as an antireflective lid and/or the at least one sample compartment is provided between the lid and the at least one light sensitive element. Thereby, it is possible to enhance the selectivity of the light detection without expensive filtering means by providing a suitable geometry of the different components of the bio chip device and/or by providing a suitable geometry to the optical axis in order to reduce the amount of reflected light and by suitably absorbing the incident light by means of the antireflective lid after its transmission through the sample compartment. Especially, the direct illumination of the light sensitive element by the incident light is sufficiently suppressed to allow detection of the much weaker fluorescence signal.

It is further preferred that the bio chip device extends parallel to a detection plane, wherein the at least one light sensitive element is provided in the detection plane, wherein at least one first filter element is provided such that the incident light is filtered prior to passing the detection plane from the second side. By means of inexpensive filter materials in realising the first filter element, it is possible to prevent unnecessary parts of the incident light from falling into the detection unit of the bio chip device, i.e. from passing of such parts of the incident light through the sample compartment. Such unnecessary parts of the incident light are by definition such parts of the spectrum that either do not (or only comparably weakly) contribute to the stimulation of fluorescence emission or such parts of the spectrum that can pass a second filter element.

It is still further preferred that the bio chip device comprises at least one second filter means, wherein the at least one second filter means is provided between the at least one sample compartment and the at least one light sensitive element. With the combination of the first and second filter means, it is possible to greatly enhance the selectivity of the detection system while still using comparably cheap components. This makes it possible to provide the bio chip device in the form of a disposable.

Furthermore, it is preferred that the bio chip device comprises a shielding means provided on the second side of the at least one light sensitive element, wherein the shielding means prevents the incident light from reaching directly the at least one light sensitive element. Thereby, it is advantageously possible to keep the assembly of the bio chip device comparably simple and easy to manufacture. For example, the shielding means can be provided in the form of an opaque layer or another non-transparent medium. The shielding means can be made of either absorbing material or reflecting materials or a combination thereof. Examples of absorbing materials are e.g. black masks. Examples of reflecting materials are e.g. metallic materials. Advantageously, the shielding means is conductive and incorporated in an electrode structure of the light sensitive element.

In a preferred embodiment of the present invention, the bio chip device extends parallel to a detection plane, wherein the at least one light sensitive element is provided in the detection plane, wherein at least one deflection element is provided in the detection plane adjacent of the at least one light sensitive element and/or that the at least one deflection element comprises a forward scattering medium or a lens. Thereby, it is advantageously possible that shadow regions “behind” the shielding means are greatly reduced by comparably cost-effective measures.

Very preferably, the at least one deflection element comprises a deflection area having a low refractive index compared to the forward scattering medium. Thereby, a still greater deflection is possible. For example, even an air gap is possible to provide such that the effect of either deflection element is greatly enhanced.

According to a further embodiment of the present invention, it is preferred that the at least one first filter means comprises at least one first polarisation filter and wherein the at least one second filter means comprises at least one second polarisation filter. Thereby, it is possible to greatly enhance the selectivity of the optical components without much increasing the overall costs of the bio chip device.

In a preferred embodiment of the present invention, the at least one first polarisation filter is most permeable for linearly polarised light in a first polarisation plane and wherein the at least one second polarisation filter is most permeable for linearly polarised light in a second polarisation plane. By a preferably 90° shift in polarisation direction of linearly polarised light, it is possible to enhance the selectivity by just two simple polarisators, e.g. polarisator films.

Very preferably, the at least one first polarisation filter is most permeable for circularly polarised light in a first polarisation sense and wherein the at least one second polarisation filter is most permeable for circularly polarised light in the first polarisation sense and wherein the bio chip device comprises a lid on the first side of the at least one light sensitive element, wherein the lid is provided as a reflective lid. Thereby, it is even possible that the same polarisation element, namely a polarisator polarising in the same polarisation sense, is possible to use for the first and the second polarisation filter. This greatly reduces the overall cost of the inventive bio chip device.

Furthermore, it is preferred that the lid is provided by a metallic reflecting lid. This is especially advantageous if the embodiment with the polarisation filters providing circularly polarised light is used because the reflected light of the incident light will be stopped by the second polarisation filter.

In a preferred embodiment of the present invention, the bio chip device comprises a first substrate, wherein the first substrate is provided as a optically transparent substrate, wherein the bio chip device comprises a shielding means, wherein the bio chip device further comprises at least one second filter means, wherein the shielding means, the at least one light sensitive element and the second filter means are provided at one side of the first substrate. Very preferably, the bio chip device comprises a second substrate, wherein the at least one sample compartment and the lid are fixed by means of the second substrate. Thereby, a very simple and cost-effective structure of the bio chip device is possible to realise.

The present invention also includes a method for the detection of fluorescent particles within at least one sample compartment, the method comprising the use of a bio chip device comprising at least one light sensitive element, the at least one sample compartment being provided on a first side of the at least one light sensitive element, wherein a light source produces incident light from a second side opposite of the first side of the at least one light sensitive element. Thereby, it is possible to greatly improve the reading out of results of biochemical assays by means of a simple yet reliably method of only illuminating the bio chip device with a light source.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

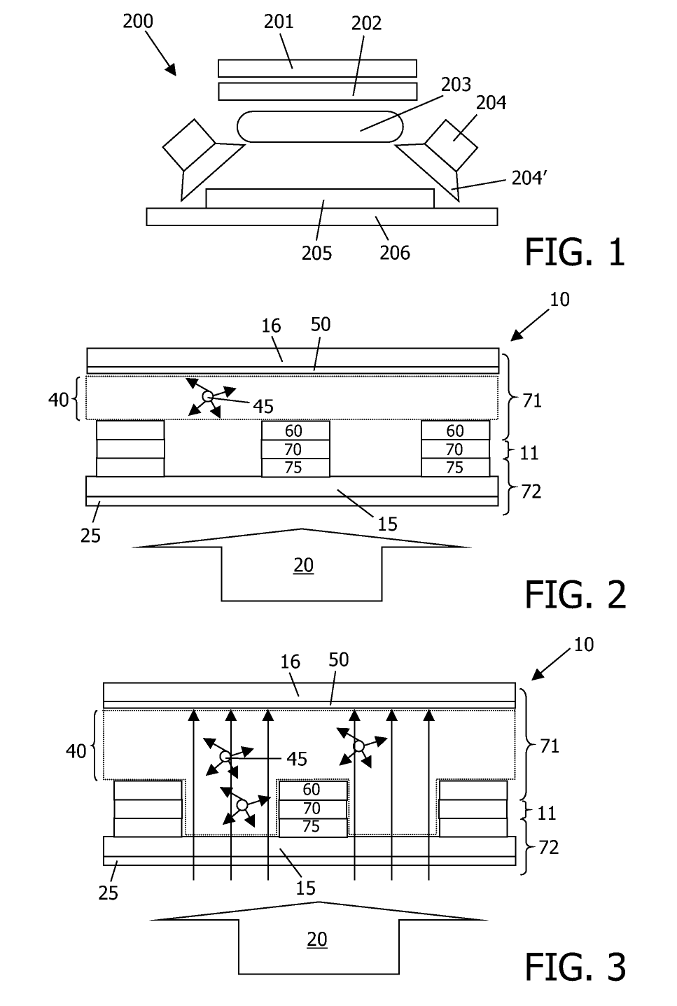

FIG. 1 illustrates schematically an optical set-up according the prior art to detect fluorescent signals coming from a bio-chip.

FIGS. 2 to 10 illustrate schematically different embodiments of the inventive bio chip device.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1, a schematic illustration of an optical set-up to detect fluorescent signals coming from a bio-chip, e.g. a micro-fluidic device, according the prior art, is shown.

Generally, as shown in FIG. 1, detection of fluorescence signals of a biochip is done using an optical detection system, comprising a light source 204, optical filters 204′ and sensors 201 (e.g. a CCD-camera, charge-coupled device), localised in a bench top laboratory machine, to quantify the amount of fluorophores present. Such arrangement normally also comprises a fluorescence filter 202, a lense 203, a fluorescent sample 205 and a carrier 206. The fluorescence detection system used in bench top/laboratory machines generally require expensive optical components to acquire and analyse the fluorescent signals. In particular, expensive optical filters with sharp wave length could off (i.e. highly selective) are used to obtain the needed sensitivity of these optical systems, as often the shift (so called Stokes shift) between the excitation spectrum (absorption) and the emission spectrum (fluorescence) is small (<50 nm). Consequently, the main sources of noise in a fluorescence based optical system are reflection of a part of the excitation light and Rayleigh-scattering of the excitation light.

In FIGS. 2 to 10, schematical representations of the overall concept of a bio-chip device 10 according to different embodiments of the present invention are shown. The bio-chip device 10 comprises a light sensitive element 70, especially a photo-diode, a photo-transistor or another photo-sensitive element like a photo-detector or another device. The light sensitive element 70 can be manufactured in different technologies, e.g. amorphous silicon, low temperature polysilicon (LTPS) or organic semiconductor technologies. It can further be provided as a TFT (thin film transistor) or a MIM (metal-insulator-metal-Technology) element or a diode element. In a preferred embodiment, the driving of the bio chip device (i.e. the reading out of the bio chip device) is made by reading out an array of photo diodes or photo transistors based on active matrix principles.

Incident light 20 is coming from beneath the light sensitive element 70 through a first substrate 15 provided as a carrier substrate 15 of the light sensitive element 70. The carrier substrate 15 or first substrate 15 is provided as a transparent substrate, e.g. made of glass or transparent plastic material. In order to shield the light sensitive element 70 from the incident light 20 coming directly into the light sensitive element 70, a shielding means 75 is provided on the first substrate 15.

A sample compartment 40 is shown above a second filter means 60. The sample compartment 40 comprises the sample, especially a liquid containing fluorescent particles 45. Generally, these are molecules, labelled with fluorophores. The fluorescent particles are activated of stimulated by the incident light 20 and emit fluorescent radiation or fluorescent light, generally randomly in all directions.

Very preferably, the bio-chip device 10 extends in a plane parallel to the main plane of the first substrate 15. The light sensitive element 70 is especially provided in the form of a layer provided on the main plane of the first substrate 15. The layer of the light sensitive element 70 defines a so called detection plane 11. From that detection plane 12 can be defined a first side 71 (“above”) and a second side 72 (“underneath”) the detection plane 11. Incident light 20 is coming from below (underneath) the detection plane 11. The structure and position of the first substrate 15 relative to the detection plane 11 (i.e. the light sensitive element 70), the shielding means 75 as well as the second filter means 60 can varied according to the needs, e.g. mechanical strength, resistance against chemically aggressive substances or the like. In FIGS. 2 to 9 one possible arrangement is shown, wherein the shielding means 75 is formed as a layer on the first substrate 15, wherein the light sensitive element 70 is formed as another layer (“above” the shielding means) on the first substrate 15, wherein the second filter means 60 is formed as a still further layer (“above” the light sensitive element 70) on the first substrate 15 and wherein all three layers are formed on the side of the first substrate 15 which is next to the sample compartment 40. Other possible arrangements of these layers relative to the first substrate 15 are schematically shown in FIG. 10. In the arrangement shown on the left hand side of FIG. 10, the layers (shielding means 75, light sensitive element 70, second filter means 60; in FIG. 10 not referenced individually) are formed on the side of the first substrate 15 which is turned away from the sample compartment 40. In the arrangement shown on the right hand side of FIG. 10, the layers (shielding means 75, light sensitive element 70, second filter means 60; in FIG. 10 not referenced individually) are formed or placed inside the first substrate 15, i.e. the first substrate 15 forms a matrix structure around the layers.

The shielding means 75 prevents the incident light from reaching directly the light sensitive element 70. Optionally, it is possible to provide the inventive bio chip device with a first filter means 25 which the incident light has to pass firstly before even reaching the shielding means 75. The shielding of the light sensitive element 70 by means of the shielding means 75 brings the problem that the collimated or non-collimated incident light 20 cannot illuminate some regions of the sample compartment 40. The fluorescent particles 45 localised in these shadow regions are therefore not stimulated to emit fluorescence light. In order to reduce this problem, the bio chip device 10 according to the present invention comprises preferably a deflection element 30 which is preferably localised in the detection plane 11 adjacent the light sensitive elements 70. The deflection element 30 provides for a different angular distribution of the directions of the incident light 20. Such a deflection element 30 (also called angular distribution altering element 30) may be positioned between the various parts of the optical sensor and may be based on scattering, diffraction and/or refraction effects. The deflection element 30 causes the scattering/the diffraction/the refraction of the incident light 20 such that excitation light can penetrate the regions of the sample compartment 40 that would be shadowed (without the deflection element 30) by the light sensitive element 70 and/or by the shielding means 75.

According to the present invention, the bio chip device 10 comprises a structure 50 which is called a lid 50 and which is used in the form of an antireflective lid 50 for the embodiments of FIGS. 2 to 7. The function of the lid 50 is in these embodiments to prevent the incident light from being reflected back into the sample compartment 40 and towards the light sensitive element 70. Thereby, it is possible to use only inexpensive first and second filter means 25, 60 and still provide for a high selectivity of the optical system. The lid 50 in its antireflective embodiment has antireflective properties and may be formed of a substantially transparent material or a substantially absorbing material or a combination of transparent and absorbing material. The possible index difference (index of diffraction) between the lid and the medium of the sample compartment 40 may still cause reflections. Therefore, the index of the lid is preferably matched with that of the medium (e.g. water) and/or an anti-reflective coating, as commonly applied in the display field, may be applied on the side of the lid facing the light source.

The light source (not shown in FIGS. 2 to 10) providing the incident light 20 may be realised by means of any of the following light sources (but not limited to): Deuterium lamp, Xenon-mercury lamp, pulsed xenon lamp, mercury lamp, continuous xenon lamp, laser and LED. Preferably, the intensity of the excitation light 20 incident on the device is tunable. Advantageously, the excitation light 20 is collimated and is incident perpendicular to the detection plane 11, i.e. parallel to the normal of the bio chip device 10, because reflections on interfaces between different media in the interior of the bio chip device 10 can thereby be reduced. It is also possible according to the present invention to provide a plurality of light sources, e.g. with different spectra of emitted light, in order to perform fluorescence spectroscopy using a variety of fluorescent molecules (e.g. varying excitation and/or fluorescent properties). In a preferred embodiment, the optical system is applied for the purpose of multiplexed real-time quantitative PCR (performed using an array of reaction chambers) in which a variety of fluorescent agents (e.g. molecular beacons) may be used. Furthermore, it is possible according to the invention, to use additional techniques to further increase the detection sensitivity of the fluorescence signal of interest, such as time-resolved fluorescent detection using a pulsed light-source. In that case, the fluorescent molecules preferably have long-wavelength excitation and emission, and/or long decay times so that background luminescence decays much faster than the luminescence of the molecule of interest.

On the first substrate 15 is optionally also provided the first filter element 25 (also called excitation filter) filtering the incident light 20 prior to entering the bio-chip device 10. The first filter element 25 may, for example, comprise alternating layers of siliconoxides, siliconnitrides and/or siliconoxynitrides in order to spectrally filter the incoming excitation light. On the first side 71 of the detection plane 11 is provided the second filter means 60 (also called detection filter) filtering the fluorescence light coming from fluorescent particles.

The structure of the light sensitive element 70 is for example provided in the form of a grid or a matrix or another special arrangement in the detection plane 11. The light sensitive element 70 is preferably made up of a plurality of distinct light sensitive elements 70 which are, however, not distinguished in the context of the present invention. It is possible according to the present invention that one or a multitude of different light sensitive elements 70 correspond to one sample compartment 40 and that another one or a multitude of other light sensitive elements 70 correspond to another of a plurality of sample compartments 40. Thereby, it is possible to read out the results of different assays performed simultaneously within the bio chip device 10.

FIG. 2 shows a cross-section through the inventive bio-chip device 10 showing that the light sensitive element 70 or the plurality of light sensitive elements 70 are separated by apertures whereby the incident light 20 can reach the interior (sample compartment 40) of the bio-chip device 10. The bio chip device 10 operates by reducing the amount of light falling directly onto the light sensitive element 70 by the shielding means 75 and reducing the amount of light falling after reflection with the lid 50 onto the light sensitive element 70, whilst allowing the light to excite fluorescent material situated in the sample compartment 40. As the fluorescent light is emitted in all directions, a considerable portion of the fluorescent light will fall onto the light sensitive element 70 as the solid angle of the light sensitive element 70 relative to the sample compartment 40 is relatively important due to the structure of the bio chip device 10 according to the invention. Thereby, a considerable gain in signal to noise ratio may be achieved.

FIG. 3 shows the shadow regions above (i.e. on the first side 71) the light sensitive element 70) created by the light sensitive elements 70 (and by the shielding means 75) being opaque.

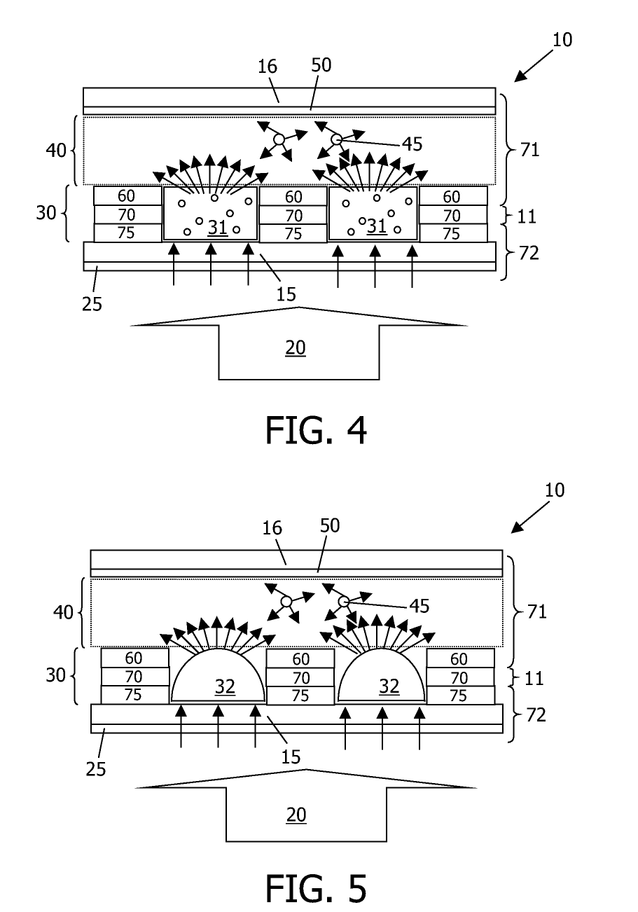

FIGS. 4 to 6 shows different preferred examples of the deflection element 30.

In FIG. 4, the deflection element 30 comprises a scattering medium 31 providing for a forward scattering of the incident light 20. One example of a scattering medium 31 is a diffusive foil. Thereby, the angular distribution of the incident light is changed such that shadow regions “behind” (in the direction of the incident light) the light sensitive element 70 are illuminated by the incident light 20. This enhances the excitation of fluorescent particles 45 in these parts of the sample compartment 40.

In FIG. 5, the deflection element 30 comprises a lens 32 which is diverting the incoming incident light 20 such that shadow regions behind the light sensitive element 70 is reduced as much as possible. A further example of a deflection element 30 is an array of lenses. When incorporating the deflection element 30, care should be taken that the re-directed incident light 20 is not directed towards the light sensitive element 70.

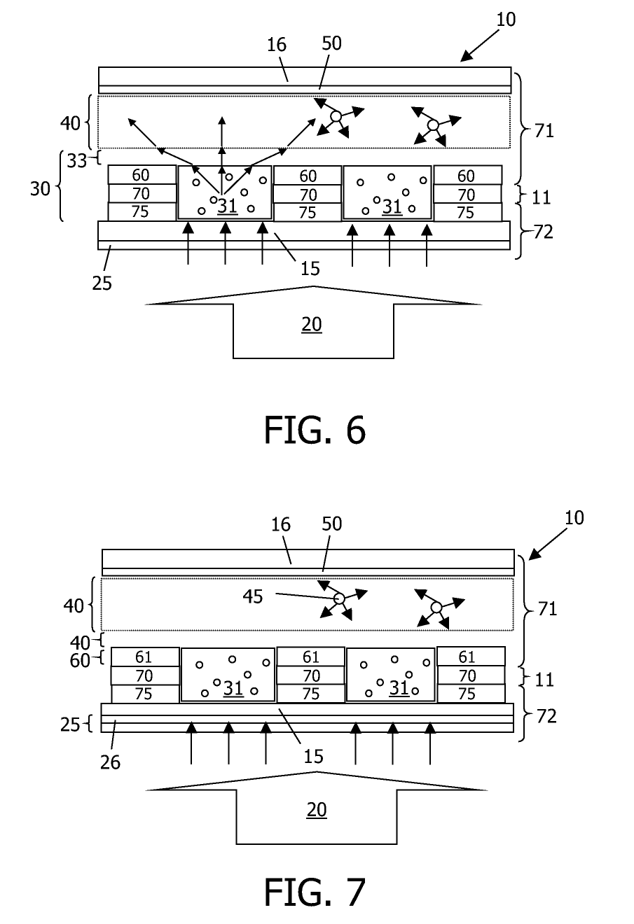

In FIG. 6, the effect of the deflection element 30 comprising the scattering medium 31 is further enhanced by means of a deflection area 33 having a low refractive index compared to the scattering medium 31. An example of such a deflection area 33 is an air gap 33 between the scattering medium 31 and the sample compartment 40. Due to the refraction at the interface with the deflection area 33 (assuming that the refractive index of the deflection area 33 is lower than the refractive index of the medium—especially the scattering medium 31), the incident light 20 can more easily penetrate the shadow regions behind the light sensitive element 70.

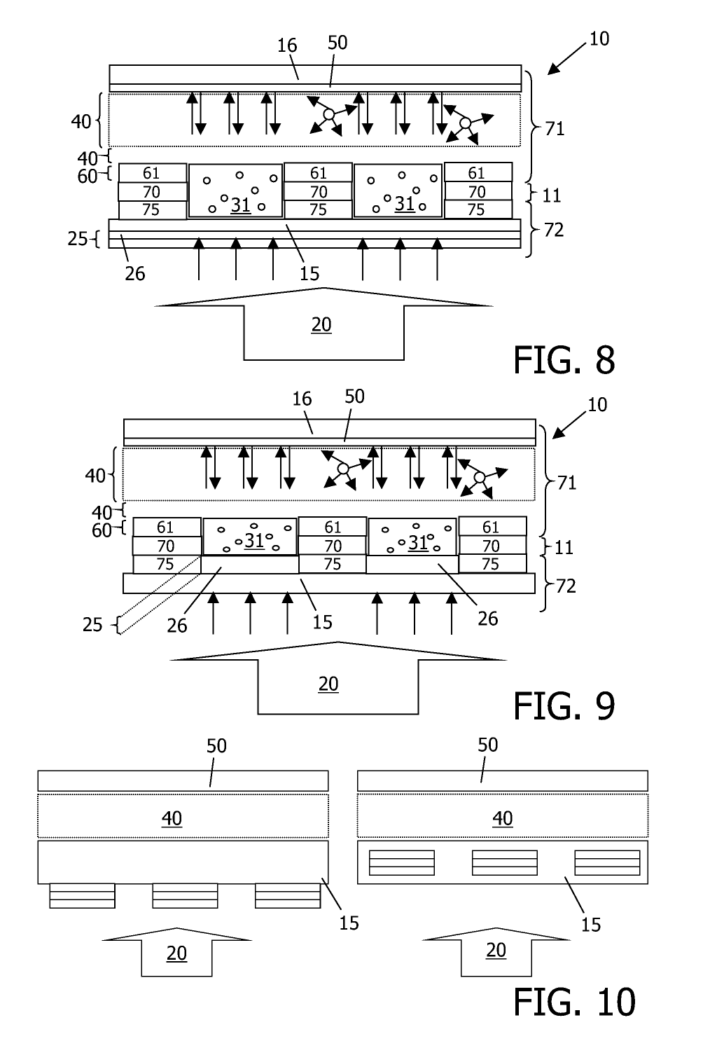

In FIG. 7 and 8, further embodiments of the bio chip device 10 are shown using polarisation means in order to suppress the illumination of the light sensitive element 70 by the incident light 20. In FIG. 7 and 8, the first filter means 25 comprises a first polarisation filter 26 and the second filter means 60 comprises a second polarisation filter 61. The second polarisation filter 61 (preferably “on the top”, i.e. on the first side 71, of the light sensitive element) prevents the illumination of the light sensitive element 70 by the polarised incident light 20 (after having passed the first polarisation filter 26). Thereby, it is possible to reduce the amount of incident light 20 falling (after reflection) onto the sensing element, whilst allowing the light to excite fluorescent particles 45. As the fluorescent light is emitted with various polarisations, a considerable portion of the fluorescent light will fall onto the sensor. In this manner, a considerable gain in signal to noise ratio may be achieved. It is advantageous to use polarisation based suppression of illumination of the optical sensor by excitation light instead of an optical (interference) filter, as sheet polarisation filters are substantially cheaper than interference filter that suppresses certain wavelengths. The incident light 20 may be polarised using a p-polarisation filter, a s-polarisation filter, a circular polarisation filter or another polarisation filter. In FIGS. 7 and 8, the embodiment of the bio chip device 10 comprising first and second polarisation filters 26, 61 is depicted comprising a scattering medium 31 and a deflection area 33. Of course, these embodiments are also possible to combine with other variations of the deflection element 30, like a lens 32 etc.

In FIG. 7, the first polarisation filter 26 is provided for a linear polarisation of the light in a first polarisation plane and the second polarisation filter 61 is provided for a linear polarisation of the light in a second polarisation plane. The first and second polarisation planes are preferably orthogonal relative to one another, thereby reducing the amount of incident light 20 falling (after reflection) onto the sensing element 70. The lid 50 is preferably antireflective similar to the previously described embodiments.

In FIG. 8, an embodiment comprising circularly polarising polarisation filters 26, 61 is depicted. In this embodiment, it is possible to use instead of the anti-reflective version of the lid 50 a reflective version of the lid 50. For example, it is possible to use a lid 50 having a metallic surface reflecting the incident light 20. If the incident light 20 is circularly polarised (by the first polarisation filter 26), the polarisation sense of the polarisation is changed during the reflection at the lid 50 (phase skipping). Thereby, it is possible to use for both the first and the second polarisation filter 26, 61 a polarisation filter providing a circular polarisation in the same polarisation sense. Due to the phase skipping at the reflection, the reflected incident light 20 is blocked at the second polarisation filter 61.

In FIG. 9, an embodiment similar to the embodiment shown in FIG. 8 is depicted. The only difference between both embodiments is that the material forming the first and the second polarisation filter 26, 61 is provided on the same side of the substrate 15 and can thereby be applied simultaneously for both polarisation filters 26, 61. This means that the circularly polarising material is applied in one step and, at a position between the shielding means 75, it realises the function of the first polarisation filter 26, and at a position above the shielding means 75 (and above the light sensitive element 70), it realises the function of the second polarisation filter 61.

1. Bio chip device (10) comprising at least one sample compartment (40) and at least one light sensitive element (70), the at least one sample compartment (40) being provided on a first side (71) of the at least one light sensitive element (70), wherein incident light (20) is provided incident from a second side (72) opposite of the first side (71) of the at least one light sensitive element (70).

2. Bio chip device (10) according to claim 1, wherein the bio chip device (10) comprises a lid (50) on the first side (71) of the at least one light sensitive element (70), wherein the lid (50) is provided as an antireflective lid (50).

3. Bio chip device (10) according to claim 2, wherein the at least one sample compartment (40) is provided between the lid (50) and the at least one light sensitive element (70).

4. Bio chip device (10) according to claim 1, wherein the bio chip device (10) extends parallel to a detection plane (11), wherein the at least one light sensitive element (70) is provided in the detection plane (11), wherein at least one first filter element (25) is provided such that the incident light (20) is filtered prior to passing the detection plane (11) from the second side (72).

5. Bio chip device (10) according to claim 1, wherein the bio chip device (10) comprises at least one second filter means (60), wherein the at least one second filter means (60) is provided between the at least one sample compartment (40) and the at least one light sensitive element (70).

6. Bio chip device (10) according to claim 1, wherein the bio chip device (10) comprises a shielding means (75) provided on the second side (72) of the at least one light sensitive element (70), wherein the shielding means (75) prevents the incident light (20) from reaching directly the at least one light sensitive element (70).

7. Bio chip device (10) according to claim 1, wherein the bio chip device (10) extends parallel to a detection plane (11), wherein the at least one light sensitive element (70) is provided in the detection plane (11), wherein at least one deflection element (30) is provided in the detection plane (11) adjacent of the at least one light sensitive element (70).

8. Bio chip device (10) according to claim 7, wherein the at least one deflection element (30) comprises a forward scattering medium (31) .

9. Bio chip device (10) according to claim 7, wherein the at least one deflection element (30) comprises a lens (32).

10. Bio chip device (10) according to claim 7, wherein the at least one deflection element (30) comprises a deflection area (33) having a low refractive index compared to the forward scattering medium (31).

11. Bio chip device (10) according to claim 4, wherein the at least one first filter means (25) comprises at least one first polarisation filter (26) and wherein the at least one second filter means (60) comprises at least one second polarisation filter (61).

12. Bio chip device (10) according to claim 11, wherein the at least one first polarisation filter (26) is most permeable for linearly polarised light in a first polarisation plane and wherein the at least one second polarisation filter (61) is most permeable for linearly polarised light in a second polarisation plane.

13. Bio chip device (10) according to claim 11, wherein the at least one first polarisation filter (26) is most permeable for circularly polarised light in a first polarisation sense and wherein the at least one second polarisation filter (61) is most permeable for circularly polarised light in the first polarisation sense and wherein the bio chip device (10) comprises a lid (50) on the first side (71) of the at least one light sensitive element (70), wherein the lid (50) is provided as a reflective lid (50).

14. Bio chip device (10) according to claim 13, wherein the lid (50) is provided by a metal lid (50).

15. Bio chip device (10) according to claim 1, wherein the bio chip device (10) comprises a first substrate (15), wherein the first substrate (15) is provided as an optically transparent substrate (15), wherein the bio chip device (10) comprises a shielding means (75), wherein the bio chip device (10) further comprises at least one second filter means (60), wherein the shielding means (75), the at least one light sensitive element (70) and the second filter means (60) are provided at one side of the first substrate (15).

16. Bio chip device (10) according to claim 1, wherein the bio chip device (10) comprises a second substrate (16), wherein the at least one sample compartment (40) and the lid (50) are fixed by means of the second substrate (16).

17. Method for the detection of fluorescent particles (45) within at least one sample compartment (40), the method comprising the use of a bio chip device (10) comprising at least one light sensitive element (70), the at least one sample compartment (40) being provided on a first side (71) of the at least one light sensitive element (70), wherein a light source (21) produces incident light (20) from a second side (72) opposite of the first side (71) of the at least one light sensitive element (70).

18. Method according to claim 17, wherein incident light (20) is absorbed by a lid (50).

19. Method according to claim 17, wherein incident light (20) is linearly polarised in a first polarisation plane (101).

20. Method according to claim 17, wherein incident light (20) is circularly polarised in a first polarisation sense (103).

21. Method according to claim 20, wherein incident light (20) is reflected by a lid (50).
